(19) United States
(12) Patent Application Publication
(10) Pub. No.: US 2008/0181401 A1
(43) Pub. Date: Jul. 31, 2008

(54) Method of Establishing a Secure Communication Link

(75) Inventors: David Picquenot, Saint Contest (FR); Gilles Macario-Rat, Vanves (FR); Pierre Lemoine, Benouville (FR)

Correspondence Address: YOUNG & THOMPSON, 209 Madison Street, Suite 500, ALEXANDRIA, VA, 22314, US

(73) Assignee: FRANCE TELECOM, Paris (FR)

(21) Appl. No.: 11/886,077

(22) PCT Filed: Mar. 2, 2006
(86) PCT No.: PCT/FR2006/000473

§ 371 Date: Oct. 10, 2007

(30) Foreign Application Priority Data
Mar. 11, 2005 (FR) 05 02441

(51) Int. Cl. H04L 9/32

(52) U.S. Cl. 380/247

(57) ABSTRACT

In a method of establishing a secure communication link between a first terminal and a second terminal, the first terminal is connected to a third terminal which can be connected to a mobile telephone network and the second terminal is connected to an authentication element of the telephone network. The method includes: transfer of an authentication datum from the third terminal to the network authentication element; following authentication of the third terminal, the transfer of a random variable from the network authentication element to the third terminal; the parallel generation of a session key by the third terminal and the network authentication element from the random variable; the generation by the first and second terminals of a shared key from the session key; and the opening of a secure communication link with the use of the shared key.

This invention relates to a method for establishing a secure communication link between a first terminal and a second terminal.

At the present time the technical means used for gaining access to a private company network from an open access network of the internet type are VPN (Virtual Private Network) techniques using IPSEC (Secure Internet Protocol) or SSL (Secure Socket Layer) standards through which an encrypted IP tunnel can be established between the user station and the company's network.

Currently available VPN are generally based on authentication and coding architectures offering either a password created by a generator or PKI (Public Key Infrastructure) architectures based on certifications stored on the user's hard disk or on smart cards inserted into card readers. Thus, depending upon the system, the generator is used to generate a single-use password, or a certification is stored either on the computer's hard disk or in a USB key or in a smart card incorporating a micro-module containing signature certifications and algorithms.

These systems have a number of disadvantages.

The use of a generator to calculate the password is not very convenient as it requires the user to read a code and to retranscribe it onto his computer.

The storage of a software certification on the computer's hard disk provides a low level of security, various attacks having been shown to be possible in a standard computer.

The use of a USB key or smart card incorporating a micro-module means that the user must have such an object, with the resulting risk of loss.

The object of the invention is therefore to overcome these disadvantages by providing a method of establishing a secure connection with a high level of security without the use of a specific object.

The object of the invention is therefore a method for establishing a secure communication link between a first terminal and a second terminal connected together by communication means, the first terminal being connected to a third terminal which is able to connect to a mobile telephone network and which comprises authentication means and the second terminal being connected to authentication means in the mobile telephone system, and in that it comprises the steps of:

a) transferring at least one authentication datum from the third terminal to the authentication means of the network through the first and second terminals,
b) after authentication of the third terminal by the network authentication means, transfer of at least one randomised sequence from the system's authentication means to the third terminal through the second and first terminals,
c) generating at least one session key by the third terminal and also by the system authentication means on the basis of the random sequence or sequences,
d) transmission of the at least one session key from the third terminal to the first terminal and by the system authentication means to the second terminal respectively,
e) generation of a shared key on the basis of the at least one session key by both the first terminal and the second terminal,
f) opening a secure communication link between the first and second terminal using the shared key.

According to embodiments of the invention the method comprises one or more of the following features:
in step d, a single session key is transmitted to the first and second terminals,
steps d) and e) are replaced by the steps:
   d′) generation of a shared key from the at least one session key by the third terminal and also by the system authentication means,
   e′) transmission of the shared key by the third terminal to the first terminal and by the system authentication means to the second terminal respectively,
the number of session keys generated is equal to the number of random sequences transferred,
the mobile telephone network operates on the GSM standard and the authentication datum from the third terminal is the IMSI or TMSI identifier and the session keys are generated from the secret Ki key paired with that identifier,
the shared key is the result of an SHA1 algorithm with a session key and SRES,
the network authentication means are replaced by a security module containing the authentication secrets.

Another object of the invention is a system for establishing a secure communication link between a first and a second terminal connected together by communication means such that
the first terminal has connection means to a third terminal which is able to connect to a mobile telephone network comprising authentication means and the second terminal comprises means for connection to the mobile telephone network authentication means, and in that the said system comprises:
   a) first means for the transfer of at least one authentication datum from the third terminal to the network authentication means via the first and second terminals,
   b) after the third terminal has been authenticated by the network authentication means, second means for the transfer of at least one random item from the network authentication means to the third terminal via the second and first terminals,
   c) first means for generating at least one session key by the third terminal and the network authentication means on the basis of a random sequence or sequences,
   d) means for transmission of the at least one session key by the third terminal to the first terminal, and by the network authentication means to the second terminal respectively,
   e) second means for generating a shared key by the first and second terminals from the at least one session key, and
   f) means for opening a secure communication link between the first and second terminal using the shared key.

Another object of the invention is a first terminal which further comprises second communication means capable of transferring authentication data from a mobile telephone network to a third terminal which can be connected to a mobile telephone network and authentication means of the said network via a second terminal, and means for establishing a secure communication link with the second terminal capable of using a shared key generated from the mobile telephone network authentication data, and
the third terminal comprising means for communication with a first terminal connected to a second terminal by communication means, these communication means being capable of transmitting and receiving authentication data from the said third terminal to the mobile telephone network and transmitting to the first terminal at least one key capable of enabling the first terminal to establish a secure communication link with the second terminal.

Other objects of the invention are:
a computer program capable of executing the said programme comprising code instructions on the terminal, which when they are executed on the said terminal perform the following steps:
the steps of the transfer of authentication data from a mobile telephone network to a third terminal capable of being connected to a mobile telephone network and authentication means of the said network via a second terminal,
the step of establishing a secure communication link with the second terminal through the use of a shared key generated from authentication data of the mobile telephone network, and
a program comprising code instructions which when they are executed on the said terminal perform the following steps:
the steps of transmission and receipt of authentication data from the said terminal to the mobile telephone network,
the step of transmitting to the first terminal at least one key which can enable the first terminal to establish a secure communication link with the second terminal.

Other advantages and characteristics of the present invention will become clear from the following detailed description which is given with reference to the appended drawings which are provided purely by way of non-limiting example and in which:

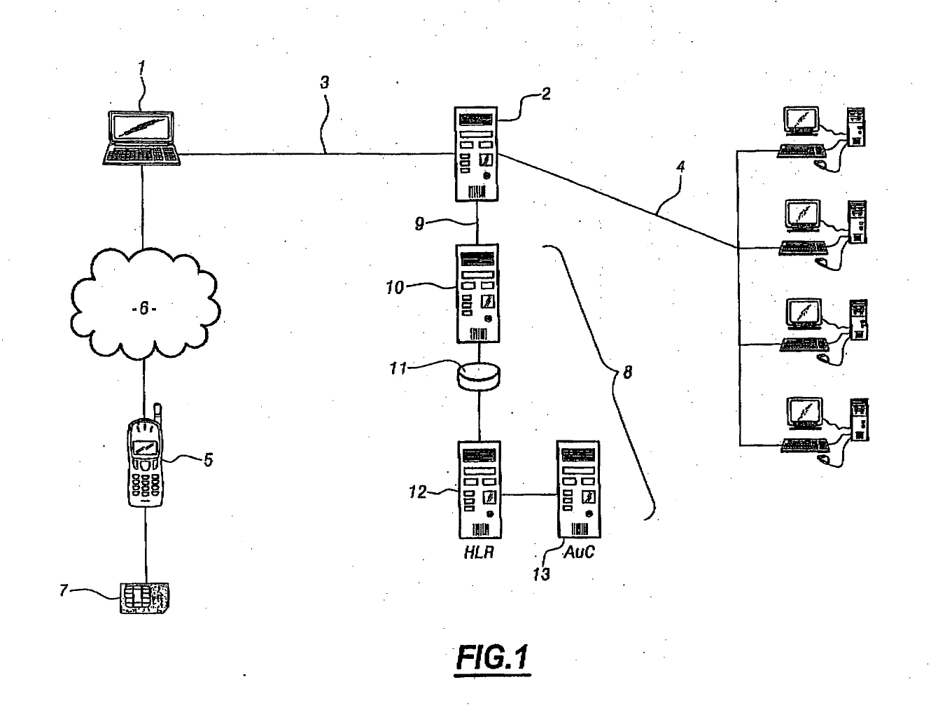

FIG. 1 is an outline diagram of the architecture of the means used by the invention,

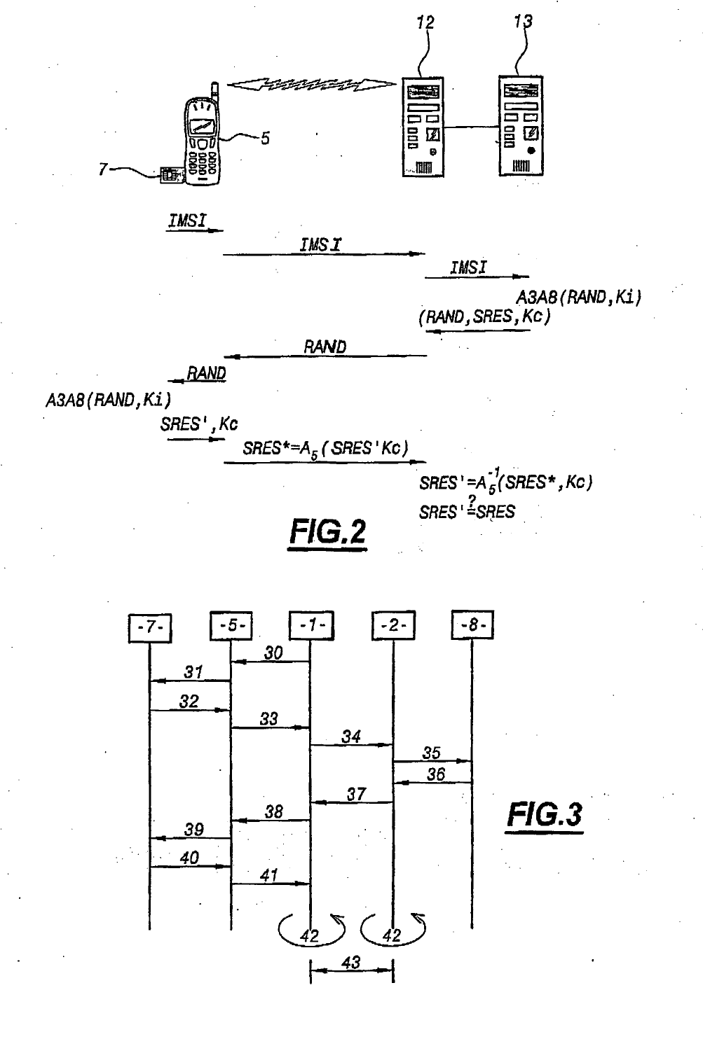

FIG. 2 is a diagram of the flow of data according to the authentication method in the GSM network,

FIG. 3 is a diagram of the flows of data according to a first embodiment of the invention, and

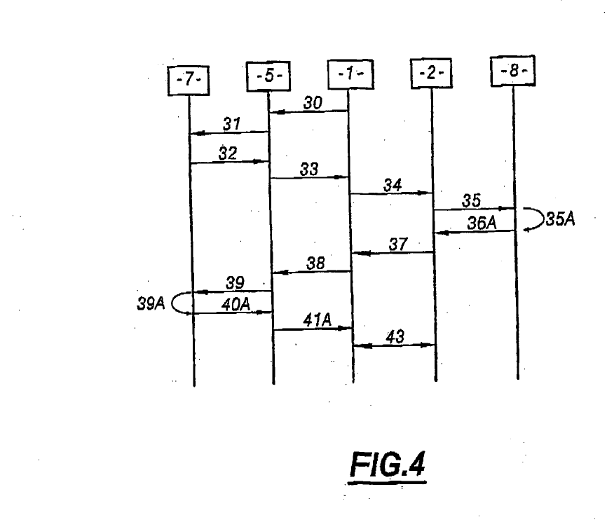

FIG. 4 is a diagram of the flows of data according to a second embodiment of the invention.

In the various figures the same reference number indicates an identical or similar item.

The method according to the invention, FIG. 1, makes it possible to establish a secure communication link between a first terminal 1 and a second terminal 2. These two terminals are connected by non-secure standard communication means 3, typically an internet connection.

Terminal 2 may be an isolated server or a gateway providing access to an internal network 4.

First terminal 1, or the client terminal, is connected to a mobile telephone 5. This connection 6 is preferably a short wave “Bluetooth” carrier radio link but may also be an infra-red link using the IrDA protocol or any other connection permitting an exchange of data between the two devices.

Any terminal capable of being connected to a mobile telephone network may perform the role of mobile telephone 5. Thus a “Smartphone”, a personal assistant or a personal computer having a connection to a mobile telephone network may be used.

Mobile telephone 5 comprises authentication means 7 in the form of an authentication module. This module is a SIM (subscriber identification module) card or a UICC (Universal Integrated Circuit Card) card.

As mobile telephone 5 preferably operates on the GSM standard, SIM card 7 has a communication interface with mobile telephone 5 which is perfectly defined by the GSM standard and in particular standard ETSI GSM 11.11.

Second terminal 2, which will also be referred to as a gateway, is connected to the authentication means 8 of the telephone network of mobile telephone 5 through a conventional data link 9.

These authentication means 8 comprise an authentication server 10 which is a machine responsible for carrying out the method and providing an interface through a MAP (Mobile Application Part) gateway 11 to the equipment of the telephone network and in particular the HLR (Home Locator Register) servers 12 and AuC (Authentication Centre) 13 which manage users in a GSM network.

Those skilled in the art will be familiar with this equipment which is particularly described in the ETSI standards.

The various steps in the method will now be described.

However, to begin with, in order to allow easier understanding of the method, a reminder of the method for authenticating a user in a GSM network in connection with standard ETSI GSM 11.11 will now be provided.

The SIM card 7, FIG. 2, stores a user identifier known as the IMSI. When the terminal is first connected this identifier is sent to the HLR server via the GSM network.

On the basis of this identifier HLR system 12 causes server AuC13 to calculate a triplet (SRES, Kc, RAND), on the basis of a secret key Ki, paired with the IMSI, in which the signed response SRES and the session key Kc are the results from a pair of standard algorithms A3 and A8 based on a random sequence RAND and key Ki. Random sequence RAND is then sent to the mobile terminal with a request for authentication.

The mobile terminal then requests SIM card 7 to execute the command RUN GSM ALGORITHM (data=<<RAND>>).

The SIM card, having in its possession the same secret key Ki and the algorithms A3 and A8, can generate SRES′ and Kc, which are returned to terminal 5.

Using Kc as the session key and the standard coding algorithm A5, terminal 5 returns SRES*=A5 (SRES′, Kc) to authentication server 12, where SRES* corresponds to SRES′ coded by algorithm A5 and key Kc.

After decoding, the HLR authentication server 12 checks that the SRES′ sent by the terminal is the same as the SRES calculated by AuC server 13. If this is the case, the terminal is then authenticated and can gain access to the network.

It should be noted that, once authenticated, mobile telephone 5 receives a temporary identifier TMSI which will have the same role as the IMSI in subsequent authentications. By thus restricting transfers of IMSI on the network the security of the system is heightened.

The method described therefore uses this authentication mechanism.

In fact the various means are related as described previously in connection with FIG. 1, client terminal 1, FIG. 3, requests its IMSI or the similar TMSI GSM identity from mobile telephone 5, steps 30 to 33.

In step 34 client terminal 1 then transmits a request for establishing a secure link together with the IMSI identity to gateway 2.

In step 35 this IMS identity is transmitted by gateway 2 to authentication means 8 of the mobile telephone network, in particular to HLR server 12.

In return, step 36, gateway 2 receives one or more random sequences A₁, . . . Aₙ as well as the corresponding session keys Kc₁, . . . , Kcₙ.

Several pairs (Aᵢ, Kcᵢ) can easily be obtained by successive execution of algorithms A3 and A8 by AuC server 13.

Gateway 2 then transmits random sequences A₁, . . . , Aₙ to terminal 1 in step 37, which transfers them to mobile telephone 5 in step 38.

This then in step 39 provides a RUN GSM ALGORITHM request to SIM card 7 in order to obtain keys Kcᵢ and results SRES′ᵢ in step 40. This request is executed as many times as there are random sequences Aᵢ.

Session keys Kcᵢ are then transmitted to first terminal 1 in step 41.

At this step in the method client terminal 1 and gateway 2 each have the set of session keys Kc₁, . . . , Kcₙ.

Terminal 1 and separately gateway 2 calculate a shared key PSK from set of keys Kc₁ . . . Kcₙ in step 42. A pseudo-random function such as SHA1 is typically used for this purpose.

As each terminal then has a common shared key PSK, and establishment of a secure link takes place in step 43 in accordance with normal protocols.

In order to implement the method described the system for establishing a secure communication link therefore comprises, in addition to the items described in connection with FIG. 1, means for establishing a secure communication link at each terminal 1 and 2 capable of generating a shared key from session keys generated by the mobile telephone and/or the authentication means of the network and then for using this shared key to establish the secure communication link.

Likewise, mobile telephone 5 in the network must comprise means 6 for communication with terminal 1, typically “Bluetooth” communication, and it must be capable of transmitting and receiving authentication data from the network through these communication means 6.

In order to do this the mobile telephone has a “Sim Access Profile” enabling access to the SIM card commands from the “Bluetooth” link.

This profile is advantageously controlled form terminal 1 by a PC/SC programming interface which thus enables the VPN application to consider the mobile telephone and its “Bluetooth” link assembly as a single smart card reader.

In a variant of the method, a single pair (RAND, Kc) is calculated. Key Kc is then used as a shared key PSK. Step 42 is therefore reduced to an identity operation.

Although simpler, this variant has the disadvantage that it increases the exposure of key Kc to attacks and thus makes the security system for the GSM network less robust.

In another variant, shared key PSK is calculated by applying a function SHA1 to key Kc and SRES, both of which have been obtained by the command RUN GSM ALGORITHM.

In a second variant, FIG. 4, which is similar to the above from the point of view of terminals 1 and 2, the latter likewise only receive a single key which is intended to be the shared key PSK. But this single key is not the same as key Kc and corresponds to the key PSK defined previously as the result of a calculation performed on the basis of keys Kc₁, . . . , Kcₙ.

This is in fact calculated in SIM card 7 and authentication means 8 separately in steps 35A and 39A on the basis of the Kcᵢ keys, as described previously, and then transferred to terminals 1 and 2, in steps 36A, 40A and 41A.

In order not to have an adverse effect on clarity of description many details of implementation which are known to those skilled in the art have not been described.

For example, many exchanges need to be encrypted in order to obtain a high level of security. This applies to the IMSI or TMSI identifier, which it is desirable should be transmitted encrypted in steps 32 to 35 in FIGS. 3 and 4. In order to achieve this the IMSI or TMSI are transmitted in code using a certified public code of GSM authentication server 11 using for example a probabilistic coding PKCS7.

Likewise, in the variant in which the PSK key is calculated by the mobile terminal and the network's authentication means, it is desirable that this key should be transmitted to the terminals in coded form.

It is also possible, in a variant implementation, to replace authentication means 8, previously described with reference to FIG. 1, by an authentication server directly connected to a GSM security processor holding the GSM secrets, or, preferably, by a single security module containing the keys corresponding to users. This advantageously makes it possible to avoid a connection to the GSM authentication infrastructure, which might be very complex.

In another embodiment the authentication step between mobile telephone 5 and the network's authentication means 12, 13 takes place conventionally through the intermediary of the telephone network. Thus only the session keys Kcᵢ and shared keys PSK are transferred to terminals 1 and 2.

A method and an associated system through which a secure communication link, in particular of the VPN type, can be established between two terminals with a high level of security and using equipment such as mobile telephones which are normally possessed by users has thus been described.

1. A method for establishing a secure communication link between a first terminal and a second terminal connected together by communication means, wherein the first terminal is connected to a third terminal which is able to connect to a mobile telephone network and comprises authentication means, the second terminal is connected to authentication means of the mobile telephone network, and it comprises the steps of:
a) transferring at least one authentication datum from the third terminal to the network's authentication means via the first and second terminals,
b) after authentication of the third terminal by the network's authentication means, transfer of at least one random sequence from the network's authentication means to the third terminal via the second and first terminals,
c) generation of at least one session key separately by the third terminal and the network's authentication means on the basis of a random sequence or sequences
d) transmission of the at least one session key by the third terminal to the first terminal, and by the network authentication means to the second terminal respectively,
e) separate generation by the first terminal and the second terminal of a shared key from the at least one session key,
f) opening of a secure communication link between the first terminal and the second terminal through use of the shared key.

2. A method for establishing a secure communication link according to claim 1, wherein in step d) a single session key is transmitted to the first and second terminals.

3. A method for establishing a secure communication link according to claim 1, wherein steps d) and e) are replaced by the steps:
d′) separate generation by the third terminal and the network authentication means of a shared key on the basis of the at least one session key,
e′) transmission of the shared key by the third terminal to the first terminal and by the network authentication means to the second terminal respectively.

4. A method for establishing a secure communication link according to claim 1, wherein the number of session keys generated is equal to the number of random sequences transferred.

5. A method for establishing a secure communication link according to, wherein the mobile telephone network operates on the GSM standard and the authentication datum for the third terminal is the IMSI or TMSI identifier and the session keys are generated from the secret Ki key paired with this identifier.

6. A method for establishing a secure communication link according to claim 5, wherein the shared key is the result from an SHA1 algorithm using a session key and SRES.

7. A method for establishing a secure communication link according to claim 1, wherein the network authentication means are replaced by a security module containing the authentication sequence.

8. A method for establishing a secure communication link between a first and second terminal connected together by communication means for implementing the method according to claim 1, wherein the first terminal has means for connection to a third terminal which is able to connect to a mobile telephone network and comprises authentication means, the second terminal has means for connection to authentication means of the mobile telephone network, and in which the said system comprises:
a) first means for the transfer of at least one authentication datum from the third terminal to the network's authentication means via the first and second terminals,
b) after the third terminal has been authenticated by the network authentication means, second means for the transfer of at least one randomised sequence from the system's authentication means to the third terminal through the second and first terminals,
c) first means for generating at least one session key by the third terminal and the network authentication means from the random sequence or sequences,
d) means for transmission of the at least one session key from the third terminal to the first terminal and by the network authentication means to the second terminal respectively,
e) second means for generation of a shared key from the at least one session key by the first and second terminals,
f) means for opening a secure communication link between the first terminal and the second terminal through the use of a shared key.

9. A terminal for implementing the method according to any claim 1, comprising means for communication with a second terminal, wherein it further comprises second communication means capable of transferring authentication data from a mobile telephone network to a third terminal which can be connected to a mobile telephone network and the authentication means of the said network via the second terminal, and means for establishing a secure communication link with the second terminal which are capable of using a shared key generated from the authentication data of the mobile telephone network.

10. A terminal capable of being connected to a mobile telephone network in order to implement the method according to claim 1, wherein it comprises means for communication with a first terminal connected to a second terminal by communication means, these communication means being capable of transmitting and receiving authentication data from the said terminal to the mobile telephone network and of transmitting to the first terminal at least one key which can enable the first terminal to establish a secure communication link with the second terminal.

11. A computer program capable of being executed on a terminal for implementing the method according to claim 1, comprising means for communication with a second terminal, wherein it further comprises second communication means capable of transferring authentication data from a mobile telephone network to a third terminal which can be connected to a mobile telephone network and the authentication means of the said network via the second terminal, and means for establishing a secure communication link with the second terminal which are capable of using a shared key generated from the authentication data of the mobile telephone network;
the program comprising coded instructions which when executed on the said terminal perform the following steps:
the steps of the transfer of authentication data from a mobile telephone network to a third terminal which can be connected to a mobile telephone network and authentication means of the said network via a second terminal,
the step of establishing a secure communication link with the second terminal through the use of a shared key generated from authentication data of the mobile telephone network,
for implementing the steps in the method as defined in claim 1.

12. A computer program capable of being executed on a terminal, capable of being connected to a mobile telephone network in order to implement the method according to claim 1, wherein it comprises means for communication with a first terminal connected to a second terminal by communication means, these communication means being capable of transmitting and receiving authentication data from the said terminal to the mobile telephone network and of transmitting to the first terminal at least one key which can enable the first terminal to establish a secure communication link with the second terminal;
the program comprising coded instructions which when executed on the said terminal perform the following steps:
the steps of transmission and receipt of authentication data from the said terminal to the mobile telephone network,
the step of transmitting to the first terminal at least one key which can enable the first terminal to establish a secure communication link with the second terminal,
to implement the steps in the method as defined in claim 1.
